(19) United States
(12) Patent Application Publication
(10) Pub. No.: US 2012/0198924 A1
(43) Pub. Date: Aug. 9, 2012

(54) Cylinder Pressure Sensor

(76) Inventors: Bernd Last, Reutlingen (DE); Christian Pottiez, Eppingen (DE); Bernd Uwe Stoller, Fellbach (DE); Georg Rixecker, Leinfelden-Echterdingen (DE); Helmut Müller, Hessigheim (DE)

(21) Appl. No.: 13/502,632

(22) PCT Filed: Sep. 9, 2010
(86) PCT No.: PCT/EP2010/005543

§ 371 Date: Apr. 18, 2012

(30) Foreign Application Priority Data
Oct. 26, 2009 (DE) 10 2009 050 911.9

(51) Int. Cl. G01M 15/08

(52) U.S. Cl. 73/114.18

(57) ABSTRACT

The invention relates to a cylinder pressure sensor comprising a housing for clamping into a cylinder head, which carries a sensor element at a front end. According to the invention, the cylinder pressure sensor has a conical seat at the front end thereof.

The invention relates to a cylinder pressure sensor having the features mentioned in the preamble of claim 1.

Such cylinder pressure sensors are clamped into cylinder heads, in the same manner as glow plugs, being screwed therein, for example, and must therefore result in sealing of the combustion chamber, and therefore considerable thermal and mechanical loads result during operation. The pressure measurements can be impaired by excessive temperatures and by an excessive distance from the combustion chamber. Contradictory requirements on the sensor element of a cylinder pressure sensor therefore result since the temperature load increases as the proximity to the combustion chamber increases.

A problem addressed by the present invention is that of demonstrating a way to measure combustion chamber pressure using a cylinder pressure sensor in a manner that is precise, reliable and economic.

This problem is solved by a cylinder pressure sensor having the features indicated in claim 1. Advantageous refinements of the invention are the subject matter of dependent claims.

A cylinder pressure sensor according to the invention comprises a conical seat at the front end thereof. By way of this simple measure, it is possible to combine good thermal coupling of the sensor element to the housing with a minimal distance from the combustion chamber and good sealing with reduced mechanical load.

Since the sensor element is located at the front end of the housing, no pressure-transmitting components are required, which is advantageous. The mechanical natural frequencies of a cylinder pressure sensor according to the invention are thus very high, and therefore a pressure sensor according to the invention has an advantageously large bandwidth. The installation position of the sensor element close to the cylinder helps to prevent the occurrence of so-called whistle oscillations in particular. Whistle oscillations are resonances of combustion gasses, which occur in the transfer passages from the combustion chamber to the sensor element and, in the worst case, can cause interferences within the bandwidth of the measurement signal.

The temperature load of a sensor element increases per se as the proximity to the combustion chamber increases, since the proximity to the combustion process increases. A conical seat, that is, a conical sealing seat, can be used to counteract said temperature load. A cylinder pressure sensor according to the invention makes it possible to utilize the relatively low temperature level of cooled (usually water-cooled) cylinder heads at the level of the seal seat as a temperature sink for the sensor element.

A cylinder pressure sensor according to the invention makes precise measurement possible in that the temperature load of the sensor element can be reduced to an unproblematic magnitude even though it is disposed close to the combustion chamber. Coking, which impairs measurement accuracy, can be counteracted by the good heat dissipation achieved according to the invention. Within the scope of the invention it was determined that practically no coking of the sensor element is observed at sensor element temperatures below 210° C. In a cylinder pressure sensor according to the invention, the surface temperature of the sensor element can be advantageously maintained in a range of approximately 170° C. to 210° C. even under high engine load.

The conical shape of the seal seat has the advantage over flat seals that a lower clamping force by way of the sensor housing is required for identical surface pressures. This makes it possible to miniaturize the housing and seal the cylinder head without an additional sealing element.

In a cylinder pressure sensor according to the invention, the sensor element itself can form the conical seat, that is, it can be mounted onto the tip of the housing. Compared to a flat seat, this results in a substantial reduction of the mechanical load of a sensor element required for a good seal. It is also possible, however, for the housing itself to form the conical seat. The sensor element can then be disposed entirely in the housing. Advantageously, it is thereby possible to ensure that absolutely no mechanical load is applied to the sensor element by the required seal. In both cases, the sensor element has good contact with the housing, thereby permitting heat to be dissipated efficiently from the sensor element by way of the housing and from the seal seat.

According to an advantageous refinement of the invention, the sensor element is covered with a protective layer. Such a protective layer can comprise one or more layers. Preferably, such a protective layer comprises a thermally insulating layer which is based on ceramic, for example. A thermally insulating layer can be applied by flame-spraying, for example. The measurement function of the sensor element is not or only insubstantially influenced by a protective layer, and the thermal load can be reduced considerably. The protective layer can cover the active surface of the sensor element, although it is also possible for the active surface to be eliminated. Preferably, the surfaces of the sensor element contacting the housing are not covered by the protective layer.

A thermally insulating layer can be combined with a thermally conductive layer, such as a metal layer, which is disposed on the thermally insulating layer and results in improved heat dissipation.

The sensor element is preferably pot-shaped. A strain gauge can be disposed in the bottom of the pot, for example, wherein heat can be efficiently dissipated to the housing enclosing the side walls by way of the cylindrical side walls of the pot. Good thermal coupling of the sensor element can be achieved in particular by pressing the sensor element into the housing.

An external thread is preferably used to clamp the housing in a cylinder head, as is common with spark plugs, for example. It is also possible, however, to clamp the cylinder pressure sensor in a manner similar to an injection valve for fuel injection.

The conical seat preferably has a seal angle of 40° to 155°, preferably 60° to 120°. The seal angle is the included angle of the cone defined by the jacket surfaces of the conical seat shaped as a truncated cone.

Further details and advantages of the invention are explained using embodiments, with reference to the attached drawings. Components that are identical or similar are labelled using the same reference numerals. Shown are:

FIG. 1 an example embodiment of a cylinder pressure sensor according to the invention;

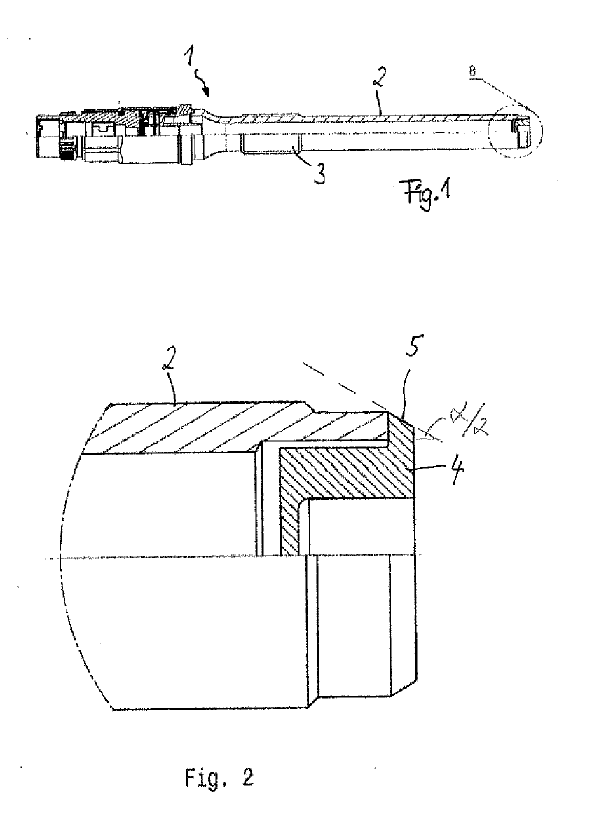

FIG. 2 a detailed view of FIG. 1; and

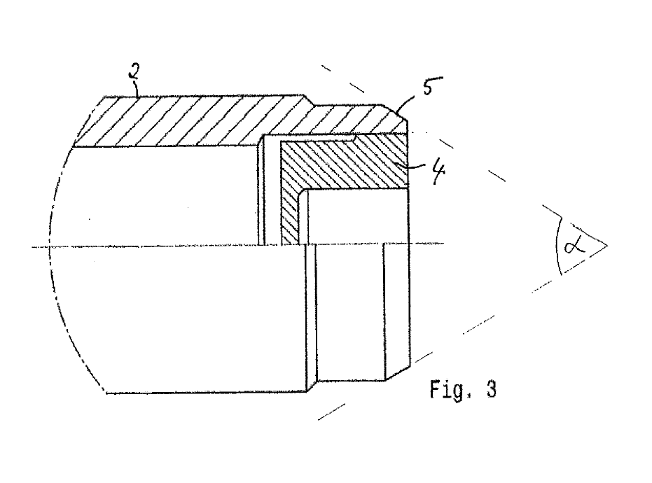

FIG. 3 a detailed view of a further example embodiment.

FIG. 1 shows a cylinder pressure sensor 1 in a partial sectional view. The cylinder pressure sensor 1 comprises a tube housing 2 which has an external thread 3 for screwing into a cylinder head, and carries a pot-shaped sensor element 4 at a front end. The cylinder pressure sensor is clamped in a cylinder head by being screwed therein. The front end of the cylinder pressure sensor 1 comprising the sensor element 4 is depicted in FIG. 2 which shows an enlarged view of the detailed section B of FIG. 1.

The sensor element 4 is mounted onto the front end of the tube housing 2 and forms a conical seat 5. The sensor element 4 therefore covers the front end of the tube housing 2 and creates a seal by way of the conical seat 5 thereof when the cylinder pressure sensor 1 is screwed into an engine block. In the example embodiment shown, the sensor element 4 is fastened to the tube housing 2 by laser welding. The sensor element 4 could also be pressed into the tube housing 2 if designed accordingly, that is, given a larger outer diameter of the cylindrical section.

The sensor element 4 is formed by a carrier which has good thermal conduction properties, is preferably metallic, and on which a strain gauge (not depicted) is disposed. The electrical resistance of the strain gauge depends on the cylinder pressure since the cylinder pressure induces a slight deformation of the carrier, which forms a diaphragm, and therefore of the strain gauge. The cylinder pressure can therefore be determined by measuring the electrical resistance of the strain gauge. In the tube housing 2, related connection lines extend to the sensor element 4, which, along with measurement and evaluation electronics, are not depicted

FIG. 3 shows a detailed view according to FIG. 2 of a further example embodiment of a cylinder pressure sensor 1 according to the invention. In the example embodiment depicted in FIG. 3, the tube housing 2 forms the conical seat 5. The sensor element 4 is press-fitted into the tube housing 2 and is disposed entirely in the tube housing 2. The sensor element can in addition be secured using laser welding. Advantageously, the pressing-in results in large-area contact between the sensor element 4 and the inner side of the tube housing 2. During operation, heat can therefore be dissipated by way of the tube housing 2 and by way of the seal seat. It is also advantageous, in particular, that the sensor element 4 is loaded practically not at all when the cylinder pressure sensor 1 is screwed in.

In both example embodiments, the conical seat has a seal angle α of more than 60°, for example 60° to 90°.

In both example embodiments, the sensor element 4 can comprise a thermally insulating protective layer. To produce such a protective layer, a ceramic-based layer can be applied by flame-spraying or a similar method, for example. Preferably, such a protective layer is disposed only at a front side of the sensor element, which faces the combustion chamber during operation.

In both example embodiments, the tube housing 2 is closed at the front end thereof by the sensor element 4. The combustion chamber pressure to be measured therefore acts directly on the sensor element 4.

### Reference Numerals

1 Cylinder pressure sensor
2 Tube housing
3 External thread
4 Sensor element
5 Conical seat

1. A cylinder pressure sensor comprising a housing for clamping into a cylinder head, said housing carrying a sensor element at a front end, wherein the cylinder pressure sensor has a conical seat at its a cylinder pressure sensor front end.

2. The cylinder pressure sensor according to claim 1, wherein the conical seat is formed by the sensor element.

3. The cylinder pressure sensor according to claim 2, wherein the sensor element covers the front end of the housing.

4. The cylinder pressure sensor according to claim 1, wherein the tube housing forms the conical seat.

5. The cylinder pressure sensor according to claim 4, wherein the sensor element is disposed entirely in the housing.

6. The cylinder pressure sensor according to claim 1 wherein the sensor element is press-fitted into the housing.

7. The cylinder pressure sensor according to claim 1 wherein the sensor element is covered by a protective layer.

8. The cylinder pressure sensor according to claim 7, wherein the protective layer comprises a thermally insulating layer.

9. The cylinder pressure sensor according to claim 1 wherein the conical seat has a sealing angle (α) of 40° to 155°.

10. The cylinder pressure sensor according to claim 1 wherein the sensor element comprises a strain gauge.

11. The cylinder pressure sensor according to claim 1 wherein the conical seat has a sealing angle (α) of 60° to 120°.

12. The cylinder pressure sensor according to claim 1 wherein the sensor element is pot shaped.

13. The cylinder pressure sensor according to claim 12 wherein a strain gauge is disposed in a bottom of the pot of a pot shaped sensor element.
